(19) United States
(12) Patent Application Publication
(10) Pub. No.: US 2008/0005980 A1
(43) Pub. Date: Jan. 10, 2008

(54) FOLDABLE SAUNA CABINET

(76) Inventor: Ding-Chen Lin, Taur-Yuan City (TW)

Correspondence Address: SCHMEISER, OLSEN & WATTS, 22 CENTURY HILL DRIVE, SUITE 302, LATHAM, NY, 12110, US

(21) Appl. No.: 11/428,615

(22) Filed: Jul. 5, 2006

(51) Int. Cl. E04G 21/14; A61H 33/06; E02D 35/00; E04B 1/00

(52) U.S. Cl. 52/127.1; 4/526

(57) ABSTRACT

Disclosed herein is a foldable sauna cabinet, comprising: a bottom base, on which having an indentation at each side of the surface, respectively; multiple panels, one end of each panel embedded in the indentation of the bottom base, and two sides of the panel are correspondingly adjacent with each other to form a predetermined space; and multiple attachments, each of which is constituted by the first fastener and the second fastener that locks with each other and is disposed on the corresponding location of the side end edge of the panel. Whereby each of the panel is mounted on the bottom base stably without movement and the design of the panel will be improved after the integration.

### FIELD OF THE INVENTION

The present invention relates to a foldable sauna cabinet, specifically, each of the panels is mounted in a fixed position on a bottom base to prevent any movement from occurring, and the appearance of the integrated sauna cabinet would be improved after installation.

### BACKGROUND OF THE INVENTION

FIG. 1, FIG. 2 and FIG. 3 are schematic views illustrating a conventional foldable sauna cabinet. The foldable sauna cabinet is constituted by a base 4, multiple walls 5, which are disposed on one surface of the base 4 and are adjacent to each other, and multiple lock parts 6, which are disposed between each wall 5. The base 4 has a separator 41 located correspondingly to every inside wall of every wall 5 for confining the walls 5 to the base 4. Every lock part 6 is constituted by a connector 61 and a fastener 62, which are provided correspondingly at the surface of each wall 5. Utilizing the integration between the connector 61 and the fastener 62, the walls 5 are firmly locked together to form a foldable sauna cabinet.

Although the foldable sauna cabinet may be combined with the base 4, multiple walls 5, and multiple lock parts 6 as described above, but each wall 5 is connected to each other through the connection of the connector 61 and the fastener 62 of the lock part 6 with each other, and the connector 61 and the fastener 62 of the lock part 6 are normally mounted on the outside surface of the walls 5 resulting in a unattractive design. The walls 5 only use the separator 41 of the base 4, which is located correspondingly to the inside surfaces of the walls 5, as the boundary of its enclosed space. When the connector 61 and the fastener 62 are unfastened, the walls 5 would be detached easily causing no harm and enhanced safety for the user.

### SUMMARY OF THE INVENTION

Therefore, the object of the present invention is to provide a stable sauna cabinet in which each of the panels is mounted on a bottom base to prevent movement from occurring, and the appearance of the cabinet integrated from the panels will be an improved design.

In order to solve the above-mentioned problems, disclosed herein is a foldable sauna cabinet comprising: a bottom base, on which having an indentation at each side of the surface, respectively; multiple panels, one end of each panel embed in the indentation of the bottom base, and two sides of the panel are correspondingly adjacent with each other to form a predetermined space; and multiple attachments, each of which is constituted by the first fastener and the second fastener that locks with each other and disposed on the corresponding location of the side end edge of the panel.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a typical view illustrating a foldable sauna cabinet;

FIG. 2 is a partially enlarged view of part A shown in FIG. 1;

FIG. 3 is a partially enlarged view of a part B shown in FIG. 1;

FIG. 4 is a typical perspective view illustrating the foldable sauna cabinet according to a preferred embodiment of the present invention;

FIG. 5 is a typical exploded perspective view illustrating the foldable sauna cabinet according to a preferred embodiment of the present invention;

FIG. 6 is a partially enlarged view of a part C shown in FIG. 5;

FIG. 7 is a partially enlarged view of a part D shown in FIG. 5;

FIG. 8 is a typical perspective view illustrating the assembly of the panel according to a preferred embodiment of the present invention;

FIG. 9 is a typical perspective view illustrating the sectional view after the assembly of the panel according to a preferred embodiment of the present invention; and

FIG. 10 is a typical sectional view after the assembly of the panel and the bottom base according to a preferred embodiment of the present invention.

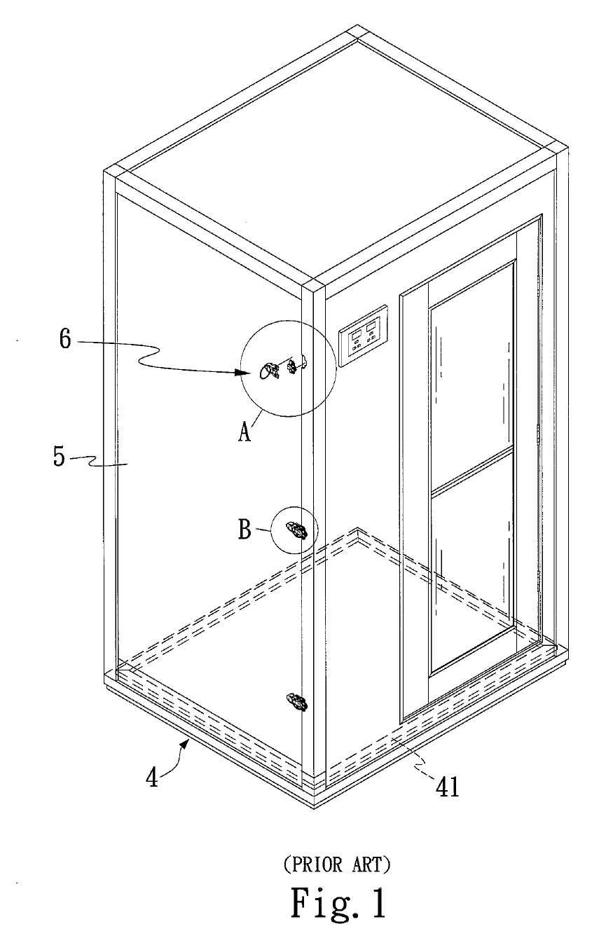

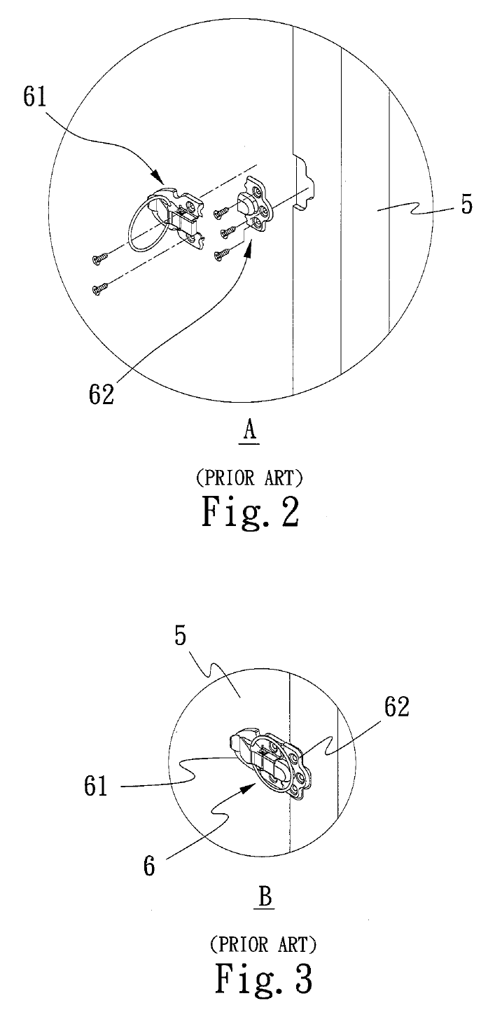

### DETAILED DESCRIPTION OF PREFERRED EMBODIMENTS

Additionally, a preferred embodiment of the present invention will be described in detail with reference to the accompanying drawings. It should be noted that the scope of the present invention is not limited by the illustrated embodiment.

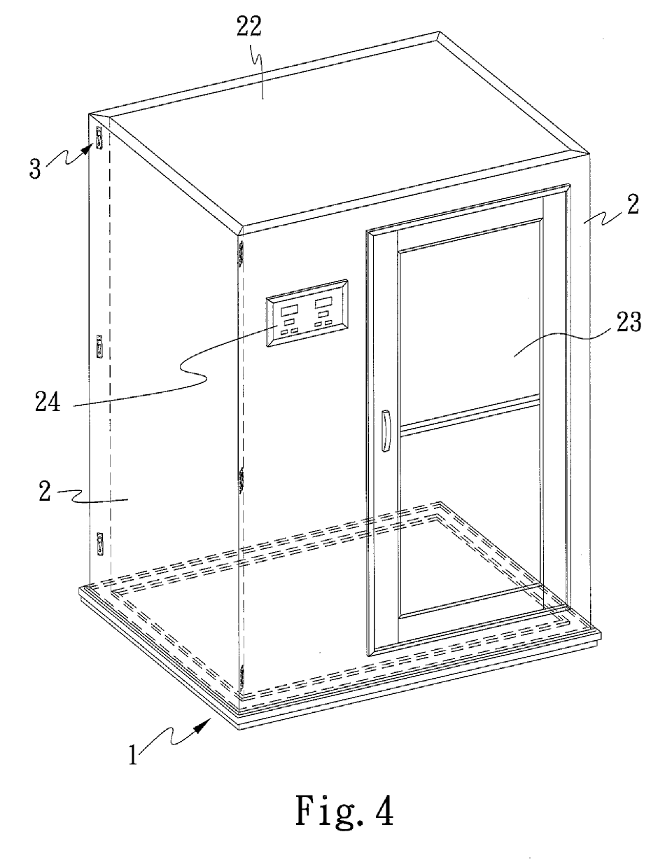

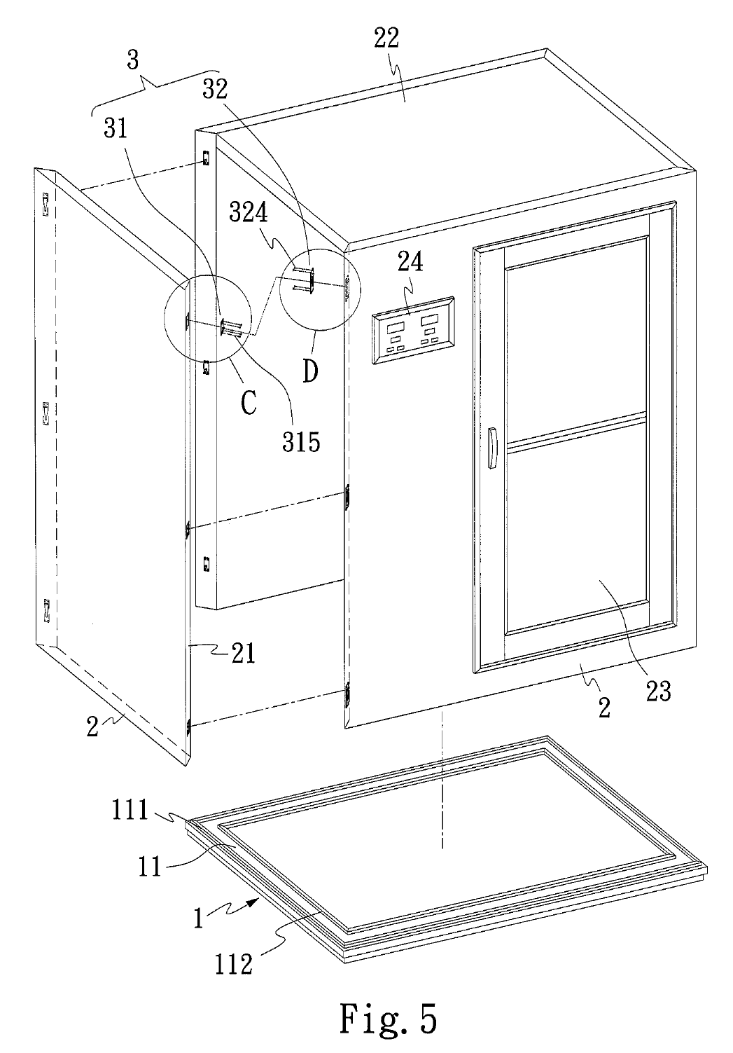

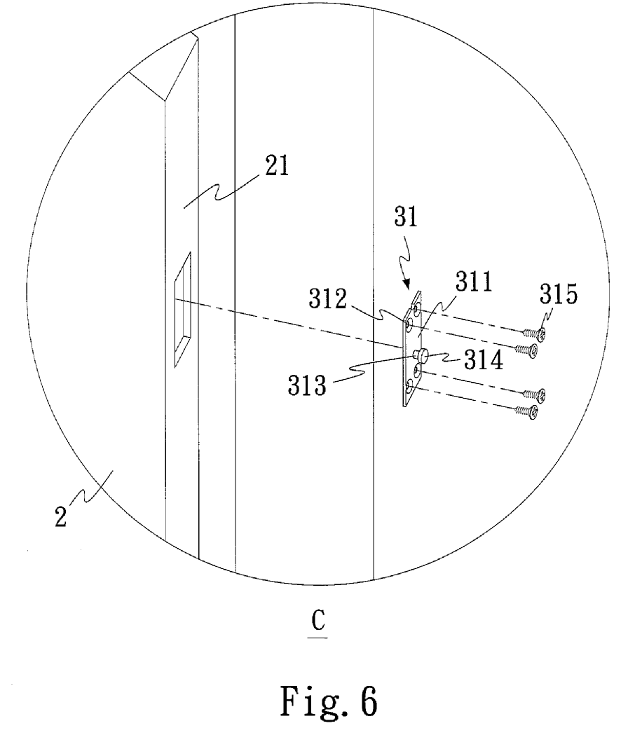

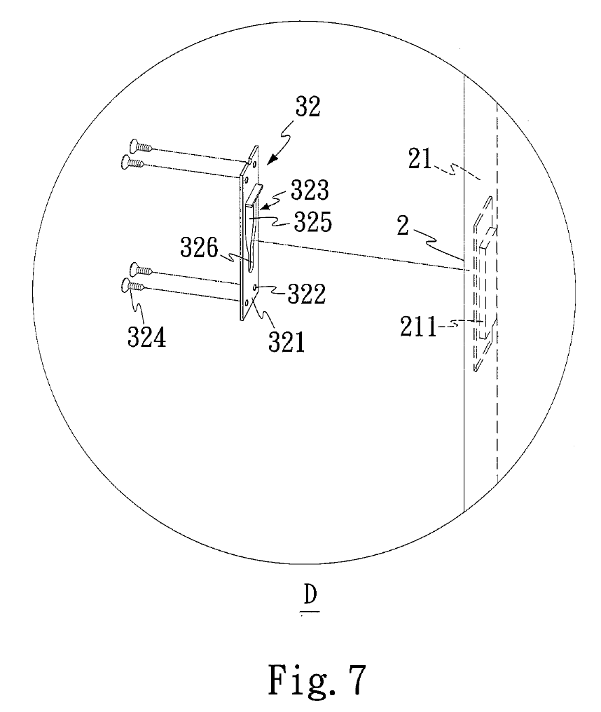

Please refer to FIG. 4, FIG. 5, FIG. 6 and FIG. 7, which are a typical perspective view, an exploded perspective view, a partially enlarged view of a part C shown in FIG. 5, and a partially enlarged view of a part D shown in FIG. 5, which are illustrating the foldable sauna cabinet according to the present invention. Disclosed herein is a foldable sauna cabinet, which is constituted by a bottom base 1, multiple panels 2, and multiple attachments 3, which make each panel 2 mounted on the bottom base 1 stable, without any movement and the design of the panel 2 will be improved after the combination.

Each side on one surface of the bottom base 1 in the above description has an indentation 11, respectively. The indentation 11 is constituted by a first separator 111, which is disposed at the one sided edge of the bottom base 1, and a second separator 112, which is disposed with the suitable distance corresponding to the one side of the first separator 111, and the height of the first separator 111 is slightly higher than the second separator 112.

The one end of each panel 2 is embedded in the indentation 11 of the bottom base 1 in the above description, and two sides of the panel 2 are correspondingly adjacent with each other to form a predetermined space, and the two sided end edge of each panel 2 is disposed as a inclined plane 21, respectively, and the other end of each panel 2 is disposed of a roof 22, furthermore, one of the panels 2 is provided as a door 23 and a display controlling device.

Each of the attachments 3 are constituted by the first fastener 31 and the second fastener 32 that locks with each other and disposed on the inclined plane 21 in the corresponding location of the side end edge of the panels 2, respectively, and the first fastener 31 is constituted by a fixed board 311, which has multiple through holes 312, a pillar 313, which is extendedly disposed on one surface of the fixed board 311, and a limitation 314, which is disposed on the one end of the surface of the pillar 313, and the through holes 312 of the fixed board 311 are fixed to the inclined plane 21 of the side edge of the panel 2 with the fixed element 315, and the second fastener 32 is constituted by the fixed board 321, which has multiple through holes 322, and a embedded groove 323, and the through holes 322 of the fixed board 324 are fixed to the inclined plane 21 of the side edge of the panel 2 with the fixed element 324 and the inclined plane 21 of the side edge of the panel 2 having a depression 211, which is corresponding to the embedded groove 323, and the embedded groove 323 is constituted by the expanded opening 324 and the reduced opening 326. Whereby to constitute a foldable sauna cabinet.

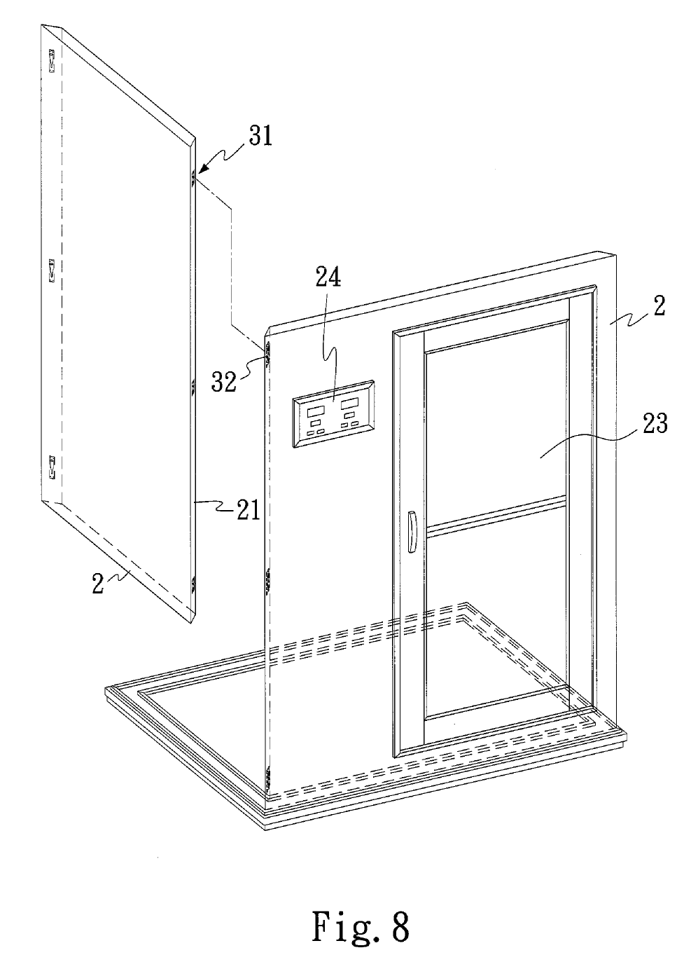

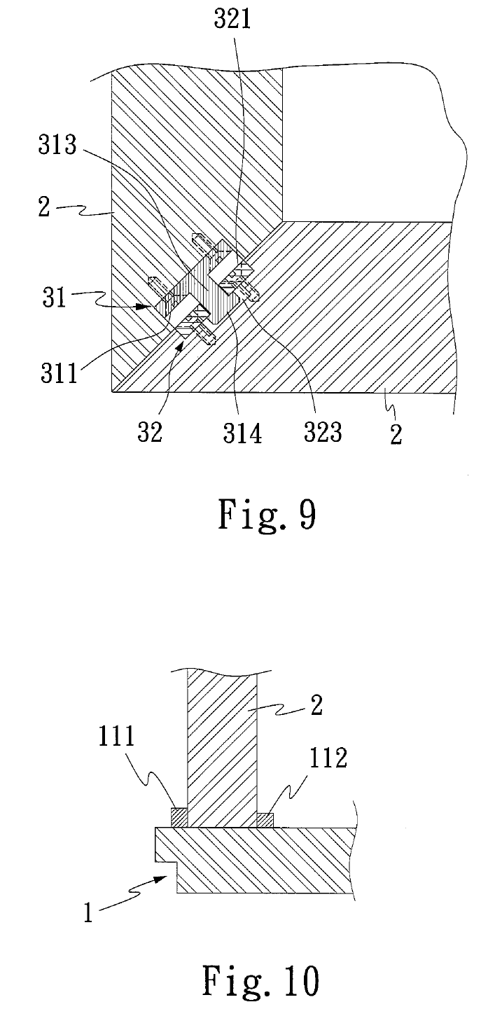

Referring to FIG. 8, FIG. 9, and FIG. 10 are a typical perspective view illustrating the assembly of the panel, the sectional view after the assembly of the panel, and the sectional view after the assembly of the panel and the bottom base. As shown in the drawing: when assembling the foldable sauna cabinet, one end of each panel 2 is embedded in the indentation 11 of the bottom base 1, then another panel 2 is taken and locked with one side of the first fastener 31 to the second fastener 32 which is disposed on one side of the panel 2 that has been embedded on the bottom base 1, and when the first fastener 31 and the second fastener 32 are locked with each other, the pillar of the first fastener 31 is inserted through the expanded opening 325 of the embedded groove which is mounted on the second fastener 32, then the pillar 313 is moved downward to the reduced opening 326 of the embedded groove 323, and the limitation 314 of the one end of the pillar 313 top id attached to the one surface of the fixed board 321 of the second fastener 32, while the one end of another panel 2 is embedded to the another indentation 11 of bottom base 1, to lock the first fastener 31 and the second fastener 32 with each other, it is not only fixed to each panel 2 to gain stability, but also makes the design of the connection of the panel 2 a smooth face and improved ergonomics.

As apparent from the above description, the foldable sauna cabinet according to the present invention has been made to solve the above problems. Each of the panels is mounted on the bottom base stably by the indentation of the bottom base and the fixed element of the two sides of the panel without movement and the design of the panel will be improved after the combination.

What is claimed is:

1. A foldable sauna cabinet, comprising:
a bottom base, which has an indentation at each side of the surface, respectively;
multiple panels, one end of each panel is embedded in the indentation of the bottom base, and two sides of the panels are correspondingly adjacent with each other to form a predetermined space; and
multiple attachments, each of which are constituted by the first fastener and the second fastener that locks with each other and disposed on the corresponding location of the side end edge of the panel.

2. The foldable sauna cabinet as set forth in claim 1, wherein
the indentation is constituted by a first separator, which is disposed at the one sided edge of the bottom base, and a second separator, which is disposed with the suitable distance corresponding to the one side of the first separator.

3. The foldable sauna cabinet as set forth in claim 2, wherein
the height of the first separator is slightly higher than the second separator.

4. The foldable sauna cabinet as set forth in claim 1, wherein
the other end of each panel is disposed as a roof.

5. The foldable sauna cabinet as set forth in claim 1, wherein
two-sided end edges of each panel is disposed as a inclined plane, respectively.

6. The foldable sauna cabinet as set forth in claim 1, wherein
the first fastener is constituted by a fixed board, which has multiple through holes, a pillar, which is extended and disposed on one surface of the fixed board, and a limitation, which is disposed on the surface of the end of the surface, and the through holes of the fixed board are fixed to the side edge of the panel with the fixed element.

7. The foldable sauna cabinet as set forth in claim 1, wherein
the second fastener is constituted by the fixed board, which has multiple through holes, and a embedded groove, and the through holes of the fixed board are fixed to the side edge of the panel with the fixed element.

8. The foldable sauna cabinet as set forth in claim 7, wherein
the embedded groove is constituted by the expanded opening and the reduced opening.
